(19) United States
(12) Patent Application Publication
(10) Pub. No.: US 2023/0251560 A1
(43) Pub. Date: Aug. 10, 2023

(54) PROJECTION DISPLAY APPARATUS

(71) Applicant: SONY GROUP CORPORATION, TOKYO (JP)

(72) Inventor: TAKEAKI HIRASAWA, TOKYO (JP)

(21) Appl. No.: 18/004,680

(22) PCT Filed: Jul. 6, 2021
(86) PCT No.: PCT/JP2021/025524

§ 371 Date: Jan. 9, 2023

(30) Foreign Application Priority Data
Jul. 16, 2020 (JP) 2020-122446

(51) Int. Cl. G03B 21/53; G03B 21/16; G03B 21/14

(52) U.S. Cl. CPC G03B 21/53; G03B 21/16; G03B 21/142

(57) ABSTRACT

A projection display apparatus according to an embodiment of the present disclosure includes: a light source unit; an image formation unit including a display device that modulates light from the light source unit on a basis of an inputted picture signal to generate a projection image; a projection unit that projects projection light generated by the display device; a signal processing unit that acquires the picture signal and performs signal processing; a correction unit including a first variation weight coefficient summation section that acquires the picture signal processed by the signal processing unit, and calculates a focus variation amount of the projection unit in accordance with a light intensity distribution of light entering the projection unit; and a focus control unit that performs focus adjustment on the projection unit on a basis of information obtained from the correction unit.

### TECHNICAL FIELD

The present disclosure relates to a projection display apparatus including a focus control mechanism.

### BACKGROUND ART

For example, PTL 1 discloses a projection display apparatus that corrects an out-of-focus condition during image projection by providing a focus correction unit that drives a focus control means on the basis of information obtained from a picture source to execute focus correction on a projection optical system.

### CITATION LIST

### Patent Literature

PTL 1: Japanese Unexamined Patent Application Publication No. 2009-223111

### SUMMARY OF THE INVENTION

Accordingly, an improvement of a quality of a projection image is demanded for a projection display apparatus.

It is desirable to provide a projection display apparatus that makes it possible to improve a quality of a projection image.

A projection display apparatus according to an embodiment of the present disclosure includes: a light source unit; an image formation unit including a display device that modulates light from the light source unit on a basis of an inputted picture signal to generate a projection image; a projection unit that projects projection light generated by the display device; a signal processing unit that acquires the picture signal and performs signal processing; a correction unit including a first variation weight coefficient summation section that acquires the picture signal processed by the signal processing unit, and calculates a focus variation amount of the projection unit in accordance with a light intensity distribution of light entering the projection unit; and a focus control unit that performs focus adjustment on the projection unit on a basis of information obtained from the correction unit.

In the projection display apparatus according to an embodiment of the present disclosure, there is provided the correction unit including the first variation weight coefficient summation section that acquires a picture signal processed by the signal processing unit, and calculates a focus variation amount of the projection unit in accordance with a light intensity distribution of light entering the projection unit. On the basis of summation results in the first variation weight coefficient summation section, a focus variation of the projection unit is predicted.

### BRIEF DESCRIPTION OF THE DRAWINGS

FIG. 1 is a block diagram illustrating an example of a configuration of a projection display apparatus according to an embodiment of the present disclosure.

FIG. 2 is an explanatory schematic view of an optical path inside a projection unit of projection light to be projected onto a screen from the projection display apparatus illustrated in FIG. 1.

FIG. 3 is a diagram illustrating an example of a temperature increase in a projection lens of the projection unit illustrated in FIG. 2 on a projection light incident side.

FIG. 4 is a diagram illustrating an example of a relationship between a light intensity distribution (A) on a screen and a temperature increase distribution (B) in the projection lens on the projection light incident side.

FIG. 5 is a diagram illustrating another example of the relationship between the light intensity distribution (A) on the screen and the temperature increase distribution (B) in the projection lens on the projection light incident side.

FIG. 6 is a diagram illustrating another example of the relationship between the light intensity distribution (A) on the screen and the temperature increase distribution (B) in the projection lens on the projection light incident side.

FIG. 7 is a diagram illustrating a difference in rates of contribution to focus variation in respective color light beams of RGB.

FIG. 8 is a diagram illustrating an example of a focus control mechanism.

FIG. 9 is a diagram illustrating the temperature increase distribution at the projection lens on the projection light incident side.

FIG. 10 is an explanatory diagram of a temperature-adjusting method using the focus control mechanism illustrated in FIG. 8 for the temperature increase distribution at the projection lens on the projection light incident side illustrated in FIG. 9.

FIG. 11 is a flowchart illustrating a flow of a focus control in the projection display apparatus illustrated in FIG. 1.

FIG. 12 is a block diagram illustrating an example of a configuration of a projection display apparatus according to a modification example of the present disclosure.

FIG. 13A is a schematic view of an example of a positional relationship between a display device and the projection unit.

FIG. 13B is a schematic view of another example of the positional relationship between the display device and the projection unit.

FIG. 14 is a schematic view of a relationship between an effective region of the projection lens and an effective pixel region of the display device.

FIG. 15 is a schematic view of an example of a direction in which the display device is shifted relative to the projection lens.

FIG. 16 is a schematic view of another example of the direction in which the display device is shifted relative to the projection lens.

FIG. 17 is a diagram illustrating an example of a relationship between the light intensity distribution (A) on the screen and the temperature increase distribution (B) in the projection lens on the projection light incident side in the positional relationship between the projection lens and the display device illustrated in FIG. 14.

FIG. 18 is a diagram illustrating another example of the relationship between the light intensity distribution (A) on the screen and the temperature increase distribution (B) in the projection lens on the projection light incident side at the time when the display device is shifted relative to the projection lens.

FIG. 19 is a diagram illustrating another example of the relationship between the light intensity distribution (A) on the screen and the temperature increase distribution (B) in the projection lens on the projection light incident side at the time when the display device is shifted relative to the projection lens.

FIG. 20 is a flowchart illustrating a flow of focus control in the projection display apparatus illustrated in FIG. 12.

### MODES FOR CARRYING OUT THE INVENTION

In the following, description is given in detail of embodiments of the present disclosure with reference to the drawings. The following description is merely a specific example of the present disclosure, and the present disclosure should not be limited to the following aspects. Moreover, the present disclosure is not limited to arrangements, dimensions, dimensional ratios, and the like of the components illustrated in the drawings. It is to be noted that the description is given in the following order.

1. Embodiment (An example of an image display apparatus provided with a correction unit including a variation weight coefficient summation part that calculates a focus variation amount of a projection unit in accordance with a light intensity distribution of light entering the projection unit)

### 1-1. Configuring of Projection Display Apparatus

### 1-2. Focus Control Method of Projection Display Apparatus

### 1-3. Workings and Effects

2. Modification Example (An example of a projection display apparatus that feeds back lens positional information in association with a lens shift mechanism to a focus control)

### 1. Embodiment

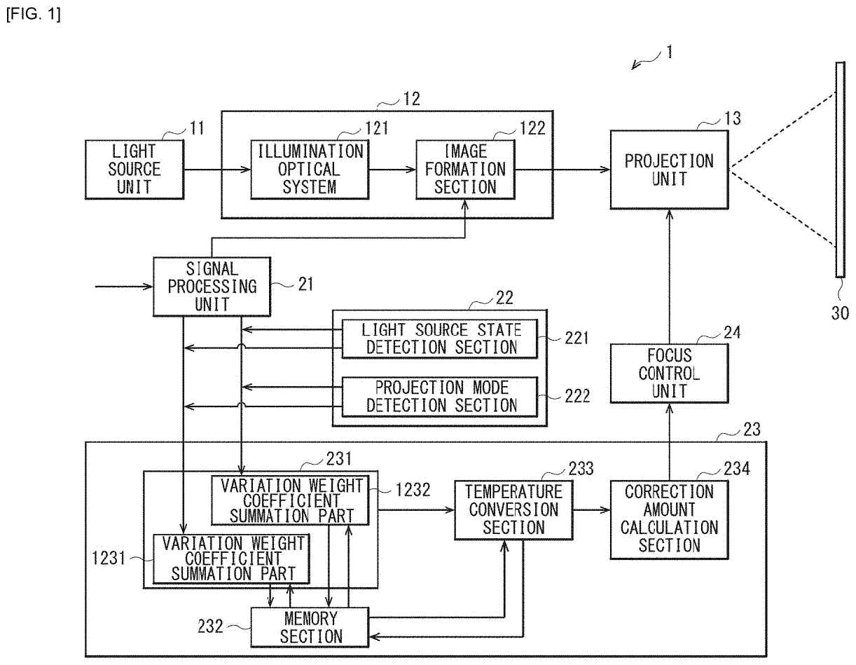

FIG. 1 is a block diagram illustrating an example of a configuration of a projection display apparatus (a projection display apparatus 1) according to an embodiment of the present disclosure. The projection display apparatus 1 enlarges and projects a projection image (projection light) created by a display device smaller than the size of an image to be projected (projection image) onto a projection surface such as a wall surface. It is to be noted here that the “image” includes a still image and a moving image.

### (1-1. Configuration of Projection Display Apparatus)

The projection display apparatus 1 includes a light source unit 11, an image generation system 12, a projection unit 13, a signal processing unit 21, a detection unit 22, a correction unit 23, and a focus control unit 24. The projection display apparatus 1 of the present embodiment includes, in the correction unit 23, a variation weight coefficient summation part 1231 that acquires a picture signal processed by the signal processing unit 21 and calculates a focus variation amount of the projection unit 13 in accordance with a light intensity distribution of picture light entering the projection unit 13. The projection display apparatus 1 predicts a focus variation of the projection unit 13 on the basis of summation results in the variation weight coefficient summation part 1231 to adjust an out-of-focus condition during projection.

The light source unit 11 includes one or a plurality of light sources. The light source is, for example, a solid-state light source that emits light of a predetermined wavelength region. Examples of the solid-state light source that can be used include a semiconductor laser (Laser Diode: LD). In addition thereto, a light-emitting diode (Light Emitting Diode: LED) may also be used.

Although not illustrated, the light source unit 11 includes, in addition to the one or the plurality of light sources, for example, a light source drive section, a light source driver that drives the light source, and a current value setting section that sets a current value in driving the light source. For example, the light source driver generates a current having a current value set by the current value setting section in synchronization with a signal inputted from the light source drive section on the basis of power supplied from an unillustrated power source unit. The generated current is supplied to the light source.

The image generation system 12 includes, for example, an illumination optical system 121 and an image formation section 122.

The illumination optical system 121 is disposed, for example, between the light source unit 11 and the image formation section 122, and includes, for example, a pair of fly-eye lenses, one or a plurality of lenses, and a color wheel. The pair of fly-eye lenses is used to homogenize an illuminance distribution of light emitted from the light source unit 11. The one or the plurality of lenses condenses light transmitted through the fly-eye lenses to a predetermined spot diameter to cause the light to enter the color wheel. The color wheel converts the light emitted from the light source unit 11 into, for example, light beams of respective colors of red light (R), green light (G), and blue light (B) in time series.

The image formation section 122 includes, for example, a display device (e.g., a display device 1221) (see FIG. 13A). The display device modulates light outputted from the illumination optical system 121 on the basis of an inputted picture signal to generate a projection image. The display device is configured by, for example, a digital micromirror device (DMD) or a transmissive or reflective liquid crystal panel.

The DMD modulates incident light spatially on the basis of a direction of reflection; for example, a large number of mirrors having high reflectance are arranged therein for respective pixels which are two-dimensionally arranged in matrix. The DMD is able to independently switch the reflective angles of individual mirrors, for example, in two directions; the tilt of the mirrors and the control of the light source unit 11 enable projection of various images.

In the liquid crystal panel, for example, a liquid crystal layer and polarization plates, which are opposed to each other with the liquid crystal layer interposed therebetween, are stacked on each other. The liquid crystal panel modulates incident light for each pixel on the basis of image signals of the respective colors of RGB to be supplied, and generates each of a red image, a green image, and a blue image.

The projection unit 13 enlarges projection light having entered from the image formation section 122, and projects the enlarged projection light onto the screen 30 or the like. The projection unit 13 includes, for example, a projection optical system 131 and a cylindrical casing 132.

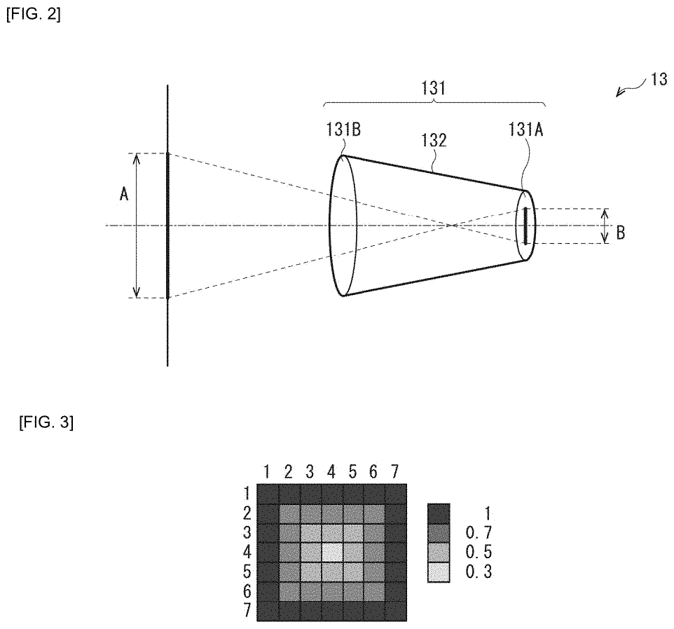

The projection optical system 131 includes one or a plurality of projection lenses (e.g., projection lenses 131A and 131B (see FIG. 2)), and these projection lenses 131A and 131B are in a state of being held by the cylindrical casing 132.

The cylindrical casing 132 is able to move wholly or partially. This allows all or some lenses of the one or the plurality of projection lenses to be moved, thus making it possible to adjust focusing (focus) of the projection light projected from the projection unit 13.

The signal processing unit 21 performs various types of processing on signals from picture signals inputted from an external apparatus such as a computer, a DVD player, or a TV tuner. The signal processing unit 21 acquires picture signals inputted from the external apparatus, and, for example, determines image size and resolution, and whether or not the image is a still image or a moving image. In a case where the image is a moving image, the signal processing unit 21 also determines image data attribution such as a frame rate. In addition, in a case where the resolution of the acquired picture signal differs from a display resolution of the display device (e.g., DMD), resolution conversion processing is performed. The signal processing unit 21 develops an image after having undergone each processing described above in a frame memory for each frame, and outputs, as a display signal, the image for each frame developed in the frame memory to each of the image formation section 122 and the correction unit 23.

For example, the detection unit 22 detects states inside and outside the projection display apparatus 1, and supplies information thereon to the correction unit 23 described later. The detection unit 22 includes, for example, a light source state detection section 221 and a projection mode detection section 222.

The light source state detection section 221 determines the deterioration state of the light source unit 11, e.g., the light source, and supplies information thereon to the correction unit 23. When the light source unit 11 is deteriorated, the amount of light emitted from the light source unit 11 varies. In such a case, even in the same picture signal, the amount of light entering the projection unit 13 varies, thus causing an out-of-focus amount to change. For this reason, in the present embodiment, supplying the deterioration information on the light source unit 11 to the correction unit 23 allows the correction unit 23 to generate a control signal in consideration of a state of the deterioration of the light source unit 11. This light source state detection section 221 corresponds to a specific example of a “first detection unit” of the present disclosure.

The projection mode detection section 222 detects, for example, a projection mode (control mode) of a projection image to be projected onto the screen 30 selected by a user, and supplies information thereon to the correction unit 23. The projection mode includes, for example, an “eco-mode” in which power consumption is suppressed, a “cinema mode” in which contrast is emphasized, a “dynamic mode” in which luminance is prioritized, and the like, and the amount of light entering the projection unit 13 varies accordingly, thus causing the out-of-focus amount to change. Therefore, in the present embodiment, supplying the correction unit 23 with a projection mode selected by the user allows the correction unit 23 to generate a control signal in consideration of the deterioration state of the light source unit 11. This light source state detection section 221 corresponds to a specific example of a “second detection unit” of the present disclosure.

Example of image quality setting of the projection image include settings such as D55, D65, and D75 for setting of a color temperature. In the above-described projection mode, even when the same white is displayed, an intensity balance among the respective colors of RGB differs, thus causing each light beam entering the projection lens to have different intensity.

The correction unit 23 generates a control signal to adjust an out-of-focus condition occurring during projection of a projection image in the projection display apparatus 1. The correction unit 23 includes, for example, a light amount summation section 231, a memory section 232, a temperature conversion section 233, and a correction amount calculation section 234.

The light amount summation section 231 temporally sums the amount of light entering the projection unit 13 (specifically, projection lens 131A), and supplies information on the summed light amount (light amount summation value) to the temperature conversion section 233.

The memory section 232 stores a control algorithm including a time factor until when the light entering the projection unit 13 (specifically, projection lens 131A) influences the focus variation. As for the correlation between the amount of light inputted (input light amount) to the projection lens 131A and the focus variation, a correlation value may be acquired in a representative individual of the same model, and the correlation value may be used as the same control algorithm for all of other individuals. Alternatively, during manufacturing steps, the correlation between the amount of light inputted to each individual and the focus variation may be acquired, and a correlation value specific to each individual may be used as a control algorithm to control the focus. Further, a time lag in the focus variation with respect to the inputted light amount may also be incorporated into the control algorithm. This makes it possible to adjust the focus at an optimum timing.

In addition, for example, in a case where the focus control unit 24 described later holds a function of controlling the amount of light emitted from the light source unit 11 in response to the display device, the amount of light emitted from the light source unit 11 may be stored in the memory section 232. This makes it possible to calculate a more precise summed amount of incident light on the projection lens 131A.

The memory section 232 further stores, in the temperature conversion section 233 described later, for example, a temperature conversion table to be used in converting the light amount summation value calculated by the light amount summation section 231 into a temperature change amount. The temperature conversion table may be created as a conversion table including results obtained by an actual experiment, or may be an approximate expression obtained from results obtained by an experiment.

The temperature conversion section 233 converts the light amount summation value calculated by the light amount summation section 231 into a temperature change amount on the basis of the temperature conversion table stored in the memory section 232, for example, and supplies information on the temperature change amount to the correction amount calculation section 234.

The correction amount calculation section 234 generates a control signal to adjust the focus of the projection lens 131A from the information on the temperature change amount of the projection lens 131A supplied from the temperature conversion section 233, and supplies the generated control signal to the focus control unit 24.

In the present embodiment, the light amount summation section 231 includes variation weight coefficient summation parts 1231 and 1232.

The variation weight coefficient summation part 1231 calculates a focus variation amount of the projection lens 131A in accordance with the light intensity distribution of light (projection light) entering the projection unit 13 (specifically, projection lens 131A), and corresponds to a specific example of a “first variation weight coefficient summation section” of the present disclosure.

In general, the projection lens has different optical paths therein depending on positions of projection images to be projected onto a screen, and the positions of the projection images contribute differently to a temperature increase in the projection lens. For example, as illustrated in FIG. 2, in a case where a projection image projected onto the screen 30 and a position substantially opposed to a plurality of projection lenses (e.g., projection lenses 131A and 131B) configuring the projection optical system 131 substantially coincide with each other, specifically, in a case where optical axes of the projection lenses 131A and 131B and the center of the projection image substantially coincide with each other, the center of the display device also substantially coincides with the optical axes of the projection lenses 131A and 131B similarly. In that case, the projection light is less likely to hit the inside of a cylindrical casing or the like with high light absorptivity, and thus a rate of contribution to the temperature increase in the projection lens 131A is lower. In addition, for example, the in-plane temperature distribution of the projection lens 131A is substantially uniform.

Meanwhile, for example, in a case where a projection image is projected upward with respect to the optical axes of the projection lenses 131A and 131B, the center of the display device is shifted and fixed in a direction opposite to the direction in which the center of the projection image is deviated from the optical axes of the projection lenses 131A and 131B. That is, the projection image is shifted and fixed downward with respect to the optical axes of the projection lenses 131A and 131B, and the optical path of the projection light entering the projection optical system 131 is biased downward in the upstream (e.g., projection lens 131A), and biased upward in the downstream (e.g., projection lens 131B). Further, in a case where there are different optical paths for each display pixel region of the display panel, the rate of contribution to the temperature increase in the projection lens 131A differs for each display pixel region. In addition, the in-plane temperature distribution of the projection lens 131A becomes uneven.

Description is given below of a conversion formula that associates light intensity in the projection image (a region A) on the screen 30 and a temperature increase in the projection lens (a region B) with each other (see FIG. 2). In the following, description is given of a temperature increase conversion formula of the projection lens 131A on a side of the light source unit 11 that, in general, contributes greatly to the variation in the focusing performance.

For the purpose of simplicity, description is given by subdividing the region A and the region B into 7×7 regions. It is to be noted that the number of divisions can be increased or decreased as needed. In addition, the shape of each of the regions A and B is not limited to a rectangular shape; for example, the regions A and B may each be divided into a shape such as a substantially circular shape or a honeycomb shape (hexagonal shape).

Suppose that ΔT (bx,by) denotes a temperature increase in each region of the region B, the following expression (1) can hold true. The temperature increase in a certain region (bx,by) in the region B is the sum of the product of an efficiency index and light intensity of all regions of the region A. The efficiency index is a function of bx, by, ax, and ay. Hereinafter, description is given thereof below by referring to specific examples.

(Mathematical Formula 1)

ΔT(bx,by)=Σε(bx,by,ax,ay)×P(ax,ay) (1)

(ε denotes an efficiency index in which light contributes to a temperature increase, and P denotes light intensity in each of 7×7 regions on a screen)

As for the projection light having entered the projection lens 131A, projection light close to an outer circumferential part is more likely to cause cylindrical casing or the like to absorb light and thus to contribute to the temperature increase, than projection light having entered a middle portion of the projection lens 131A. Thus, for example, as illustrated in FIG. 3, the light absorptivity in each of 7×7 regions of the region A is defined. In the region B, it is assumed that a location away by each one region is subjected to a temperature increase by the multiplication of 50%, i.e., the same region is subjected to a temperature increase by 100%, an adjacent region by 50%, and a further adjacent region by the square of 50%. It is to be noted that, in the region A and the region B, it is assumed that projection light passes through a region where vertical and horizontal inversions have been performed. As an example, “the same region” in the projection lens 131A (region B) in a case where projection light is projected onto (ax,ay)=(1,4) of the screen 30 (region A) is (bx, by)=(7,4) where vertical and horizontal inversions from the region A have been performed and where the projection light enters.

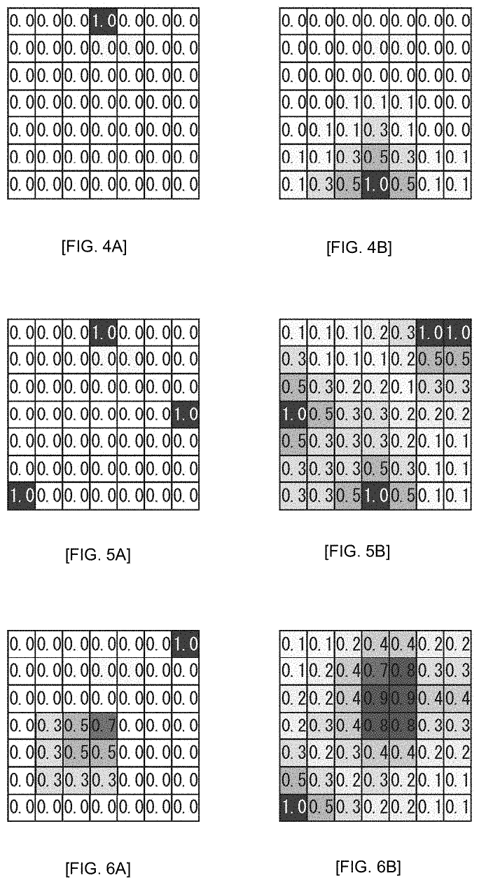

FIGS. 4 to 6 each illustrate an example of a relationship between light intensity (A) in each of the 7×7 regions of the region A and a temperature increase (B) in each of the 7×7 regions of the region B in consideration of those described above. As illustrated in FIGS. 4 to 6, it is possible to convert, from the light intensity of each of the 7×7 regions of the region A on the screen 30, a temperature increase in each of the 7×7 regions in the projection lens 131A (region B). It is appreciated, in the region A and the region B, that corresponding positions in respective regions are inverted vertically and horizontally.

It is to be noted that, in reality, a function that associates the light intensity of each of the 7×7 regions of the region A and the temperature increase in each of the 7×7 regions of the region B with each other differs depending on each particular performance of the projection display apparatus. Therefore, it is preferable to define a relational expression by analysis, actual measurement, or the like of each individual.

A variation weight coefficient summation part 1322 calculates a focus variation amount of the projection lens 131A depending on light (projection light) entering the projection unit 13 (specifically, the projection lens 131A), and corresponds to a specific example of a “second variation weight coefficient summation section” of the present disclosure.

In general, a projection image in the projection display apparatus is displayed in full color by means of synthesis of respective displayed images of RGB; the light absorptivities of members of the projection lenses 131A and 131B vary depending on the wavelength (color), and thus the rates of contribution of the respective color light beams of RGB to the temperature increase in the projection lenses 131A and 131B differ from each other.

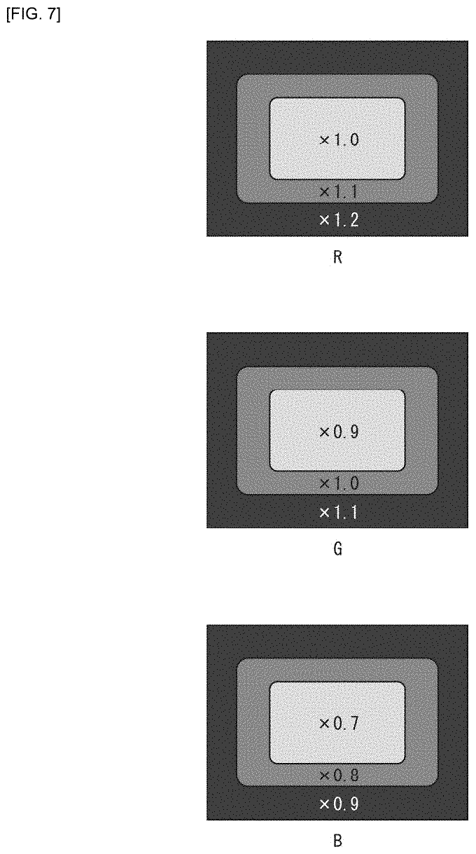

FIG. 7 illustrates an example of setting of a weight coefficient reflecting a difference in the rates of contribution of the red light (R), the green light (G) and the blue light (B) to focus variations. As for the respective color light beams of RGB, the red light (R) has the largest rate of contribution to the focus variation, the green light (G) has the next largest rate of contribution to the focus variation, and the blue light (B) has the smallest rate of contribution to the focus variation. In this manner, using separate summed light amount quasi-rates in images of the respective color light beams of RGB makes it possible to predict a more accurate focus variation and to perform precise focus adjustment.

On the basis of a control signal supplied from the correction amount calculation section 234 of the correction unit 23, the focus control unit 24 adjusts the focus variation of, for example, the projection lens 131A of the projection unit 13 to thereby adjust an out-of-focus condition during projection. The focus control unit 24 includes, for example, a control mechanism that directly moves the back-focus of the projection lens 131A. Alternatively, the focus control unit 24 may include, for example, one or a plurality of temperature adjustment mechanisms that adjust the focusing of the projection lens 131A by means of a temperature control. Examples of the one or the plurality of temperature adjustment mechanisms include a fan, a Peltier element, and a heater.

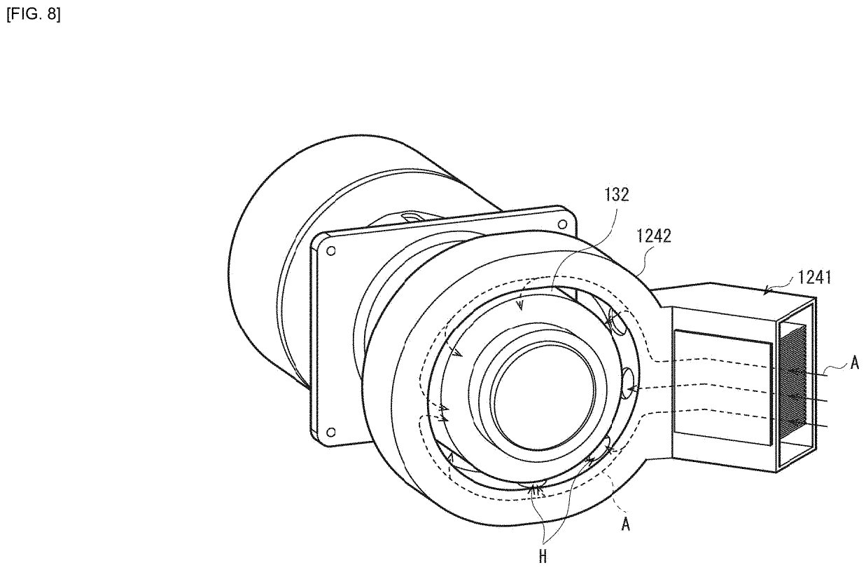

FIG. 8 illustrates an example of a focus control unit 241. The focus control unit 241 includes a heat dissipation section 1241 accommodating a plurality of fins, and a duct 1242 extending continuously from the heat dissipation section 1241 to surround the cylindrical casing 132. The duct 1242 is provided with a plurality of (e.g., eight) openings H facing the cylindrical casing 132, and, for example, air A having passed through the heat dissipation section 1241 is blown to a side surface of the cylindrical casing 132.

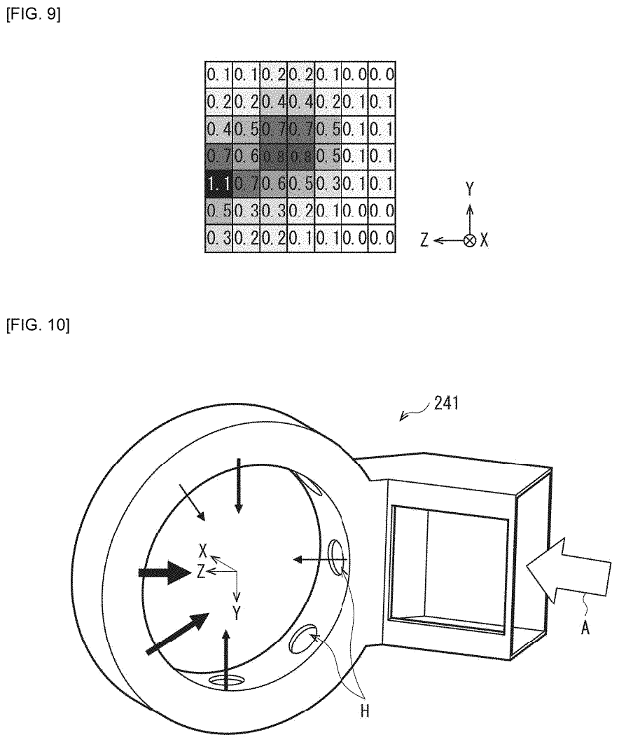

FIG. 9 illustrates an example of a temperature increase in each region when the projection lens 131A is divided into the 7×7 regions as described above. In a case where the projection lens 131A has a temperature distribution as illustrated in FIG. 9, for example, the air volume of the air A to be blown from the corresponding opening H may be adjusted depending on the magnitude of the temperature increase, as illustrated in FIG. 10. As for the adjustment of the air volume, for example, it is possible to provide an opening/closing mechanism in each of the openings H for the control thereof. Providing such a focus control mechanism makes it possible to improve the temperature control of a projection lens 410, i.e., the precision in the focus control.

### (1-2. Focus Control Method of Projection Display Apparatus)

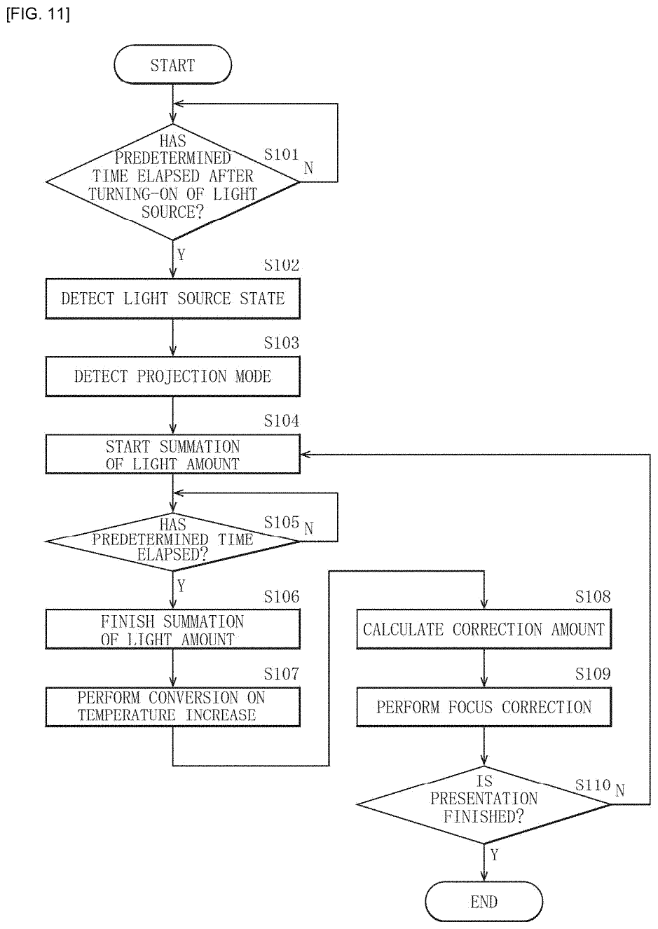

Description is given of a focus control of the projection display apparatus 1 during projection, with reference to a flowchart illustrated in FIG. 11.

Upon starting the focus control, first, it is confirmed whether or not a predetermined time has elapsed since the light source unit 11 was turned on (step S101). As for the confirmation as to whether or not the predetermined time has elapsed, it is sufficient to measure the time using a built-in timer, for example, after the light source unit 11 was turned on, and to confirm whether or not the measured time has exceeded the predetermined time stored in advance in the memory section 232 or the like.

In a case where the predetermined time has elapsed, the light source state detection section 221 confirms a state of the light source unit 11, and acquires deterioration information on the light source unit 11 (step S102). In a case where the predetermined time has not elapsed, step S101 is executed after the predetermined time.

Next, the projection mode detection section 222 confirms a projection mode selected by the user, and acquires information thereon (step S103). Subsequently, the light amount summation section 231 starts summation of the amount of light entering the projection unit 13 (step S104). Here, in the variation weight coefficient summation part 1231, the mathematical expression represented in the above formula (1) is used to calculate the focus variation amount of the projection unit 13 corresponding to the light intensity distribution of light (projection light) entering the projection unit 13. In the variation weight coefficient summation part 1322, the focus variation amount of the projection lens 131A corresponding to the wavelength of the light (projection light) entering the projection unit 13 is calculated.

When the above-described summation of the light amount is started, it is confirmed whether or not the predetermined time has elapsed (step S105). As for the confirmation as to whether or not the predetermined time has elapsed, similarly to the case of step S101, it is sufficient to measure the time using the built-in timer, for example, and to confirm whether or not the measured time has exceeded the predetermined time stored in advance in the memory section 232 or the like.

In a case where the predetermined time has elapsed, the light amount summation section 231 finishes the summation of the light amount (step S105). In a case where the predetermined time has not elapsed, step S105 is executed after the predetermined time.

Next, the temperature conversion section 233 acquires, from the light amount summation section 231, a light amount summation value in each region of the projection unit 13 (specifically, projection lens 131A), and calculates a temperature change amount in each region of the projection unit 13 (step S107). Subsequently, the correction amount calculation section 234 acquires, from the temperature conversion section 233, a temperature change amount in each region of the projection unit 13, calculates a focus correction amount in the projection unit 13, and generates a control signal to be supplied to the focus control unit 24 (step S108).

The focus control unit 24 performs focus adjustment on the projection unit 13 on the basis of the control signal supplied from the correction amount calculation section 234 (step S109). Thereafter, for example, the correction amount calculation section 234 determines whether or not the presentation is finished (step S110). As for this step, for example, it is sufficient to confirm whether or not a picture signal is outputted to the signal processing unit 21. In a case where the presentation is not finished, steps S104 to step S110 are repeated.

### (1-3. Workings and Effects)

In the projection display apparatus 1 of the present embodiment, the light amount summation section 231 of the correction unit 23 is provided with the variation weight coefficient summation part 1231 that calculates the focus variation amount of the projection unit 13 in accordance with the light intensity distribution of light (projection light) entering the projection unit 13. Also in consideration of results of the summation in this variation weight coefficient summation part 1231, a focus variation of the projection unit 13 is predicted. This is described below.

The projection display apparatus generally includes a projection lens, and enlarges by the projection lens and forms an image created by a display device smaller than the size of an image to be projected, thereby achieving large-screen display. In the projection display apparatus, allowing an image-forming point of the projection lens to precisely coincide with a screen-display device such as a screen has an influence on the quality of an image to be projected (projection image). For example, in a case where the image-forming point of the projection lens and the position of the screen do not coincide with each other, an unclear image is displayed on the screen.

However, the position of the image-forming point of the projection lens generally has temperature characteristics due to the expansion and contraction of the lens, the temperature characteristics of the optical property of the lens, the expansion and contraction of a cylindrical casing structure holding the lens, and the like. Therefore, even when the focus is adjusted in a certain projection image and the image-forming point of the projection lens and the position of the screen are allowed to coincide with each other, the projection image causes the position of the image-forming point to vary, thus making it difficult to constantly maintain the image-forming point in an optimally adjusted state.

For example, in a case where the image to be projected is dark in the projection display apparatus, an image entering the projection lens is also dark, thus leading to a state where there is a small light amount. Meanwhile, in a case where the image to be projected is bright, the image entering the projection lens is also bright, thus leading to a state where there is a large amount of light. That is, the brightness and darkness of the image to be projected causes the amount of light entering the projection lens to change in a real-time manner, and the image-forming point of the projection lens also changes accordingly in a real-time manner.

Therefore, even when a user adjusts the focus in a certain projection image and makes an adjustment to allow the position of the screen and the image-forming point to coincide with each other, the change in the brightness and darkness of the projection image causes a variation in the image-forming point, thus making it difficult to constantly view a clear projection image in which the position of the screen and the image-forming point coincide with each other.

Examples of a method for suppressing the variation in the image-forming point of the projection lens due to the change in the amount of light entering the projection lens as described above include controlling the heating of a plurality of projection lens groups arranged in a light-traveling direction to eliminate the variation in the focus position of the projection optical system associated with the temperature increase in the projection lens. In addition, examples thereof include a method for cooling the inside of the cylindrical casing provided with the projection lens to thereby cool an aberration correction lens and to suppress a change in the aberration of the projection lens caused by the temperature increase. In addition thereto, examples thereof include eliminating non-uniformity in the temperature in a planar direction by providing a plurality of temperature-measuring devices and temperature control devices in a planar direction (a direction perpendicular to an optical axis of a projection image to be projected).

In any of the above-described methods, the following five issues are conceivable. First, for example, the temperature-measuring device hinders the projection image from being displayed, and thus is not able to be disposed in an optical component effective part of the projection lens. Therefore, the temperature-measuring device is disposed in a non-effective part; however, it is difficult to estimate the temperature of an effective optical path part, which is important to optical performance, from the result of the temperature of the non-effective part, and the measuring precision thereof may be low in some cases. Second, a space is necessary for disposing the temperature-measuring device; however, in general, an optical path and a peripheral structure for displaying the projection image are disposed around the projection lens, and thus the space constraint tends to be severe. Third, the cost for the temperature-measuring device is increased. Fourth, the temperature-measuring device is able to acquire only the temperature of the arranged location, and thus the correspondence to the temperature distribution is limited. Fifth, in a case where the focus is controlled only on the basis of temperature information, a temperature change thereafter is not able to be predicted, and thus the frequency and convergence of the temperature control become insufficient.

In contrast, in the projection display apparatus 1 of the present embodiment, the light amount summation section 231 of the correction unit 23 is provided with the variation weight coefficient summation part 1231 that calculates the focus variation amount of the projection unit 13 in accordance with the light intensity distribution of light (projection light) entering the projection unit 13, and, also in consideration of the result of summation in this variation weight coefficient summation part 1231, the focus variation of the projection unit 13 is predicted. This enables the focus control in consideration of the light intensity distribution of light (projection light) entering the projection unit 13, thus making it possible to accurately adjust the out-of-focus condition during projection.

As described above, according to the projection display apparatus 1 of the present embodiment, it is possible to improve the quality of the projection image.

Next, description is given of a modification example of the present disclosure. Hereinafter, components similar to those of the foregoing embodiment are denoted by the same reference numerals, and descriptions thereof are omitted as appropriate.

### 2. Modification Example

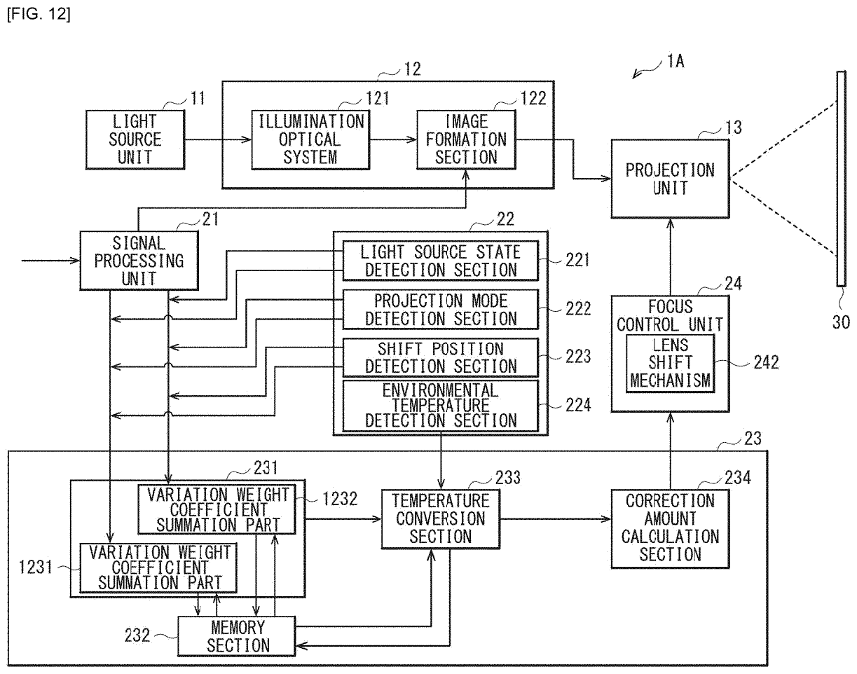

FIG. 12 is a block diagram illustrating an example of a configuration of a projection display apparatus (a projection display apparatus 1A) according to a modification example of the present disclosure. The projection display apparatus 1A of the present modification example differs from the foregoing embodiment in that the focus control unit 24 has a lens shift mechanism 242 as the focus control mechanism, and the control algorithm further includes, as variables of the focus adjustment, an environmental temperature and a relative position between the display device (e.g., display device 1221) and the projection unit 13.

The projection display apparatus 1A includes the light source unit 11, the image generation system 12, the projection unit 13, the signal processing unit 21, the detection unit 22, the correction unit 23, and the focus control unit 24.

The detection unit 22 includes, in addition to the light source state detection section 221 and the projection mode detection section 222, a shift position detection section 223 and an environmental temperature detection section 224.

The correction unit 23 includes, for example, the light amount summation section 231, the memory section 232, the temperature conversion section 233, and the correction amount calculation section 234. As described above, the memory section 232 stores a control algorithm further including, as variables of the focus adjustment, the environmental temperature and the relative position between the display device (e.g., display device 1221) and the projection unit 13.

As described above, the focus control unit 24 includes the lens shift mechanism 242 that adjusts the relative position between the display device 1221 and the projection unit 13.

The shift position detection section 223 detects the relative position between the display device 1221 and the projection unit 13 (specifically, projection lens 131A), and supplies a shift amount thereof to the correction unit 23.

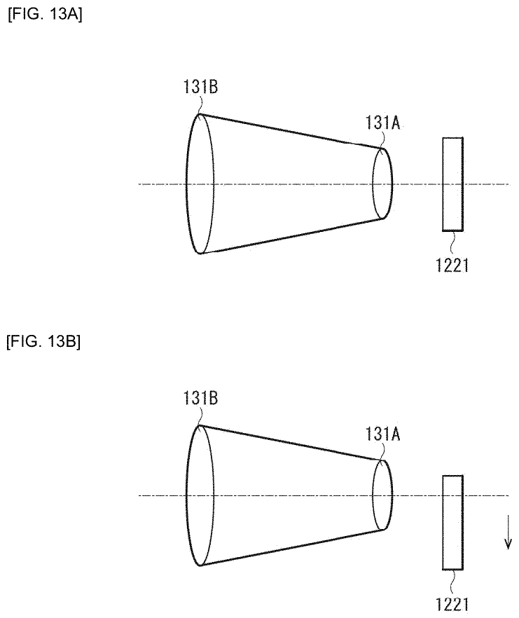

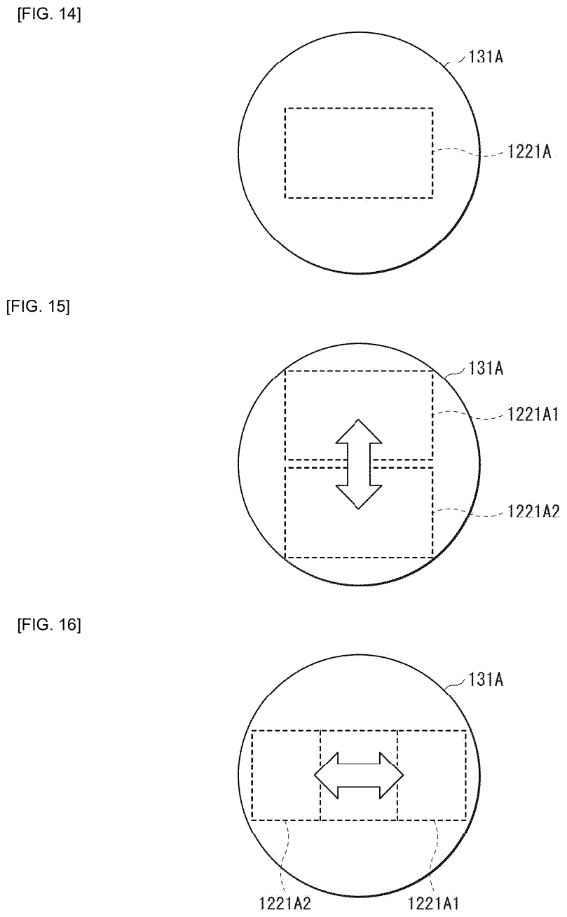

In general, the projection display apparatus includes a lens shift mechanism (e.g., lens shift mechanism 242 described later). The lens shift mechanism 242 is provided to adjust the relative position between the display device (e.g., display device 1221) and the projection lens (e.g., projection lens 131A). For example, it is possible for the lens shift mechanism 242 to shift, from a state where the center positions of the projection lens 131A and the display device 1221 coincide with each other as illustrated in FIG. 13A, the display device 1221 in any direction from the center of the projection lens 131A as illustrated in FIG. 13B. For this reason, as illustrated in FIG. 14, the projection lens 131A has an effective region larger than an effective pixel region 1221A of the display device 1221, and is able to appropriately adjust an irradiation position of projection light on the projection lens 131A as in effective pixel regions 1221A1 and 1221A2, as illustrated in FIGS. 15 and 16, for example.

However, in a case where the lens shift mechanism 242 shifts the relative position between the projection lens 131A and the display device 1221, the rate of contribution to the temperature increase for each region of the projection lens 131A varies depending on the position of the effective pixel region 1221A of the display device 1221 even in the same picture signal.

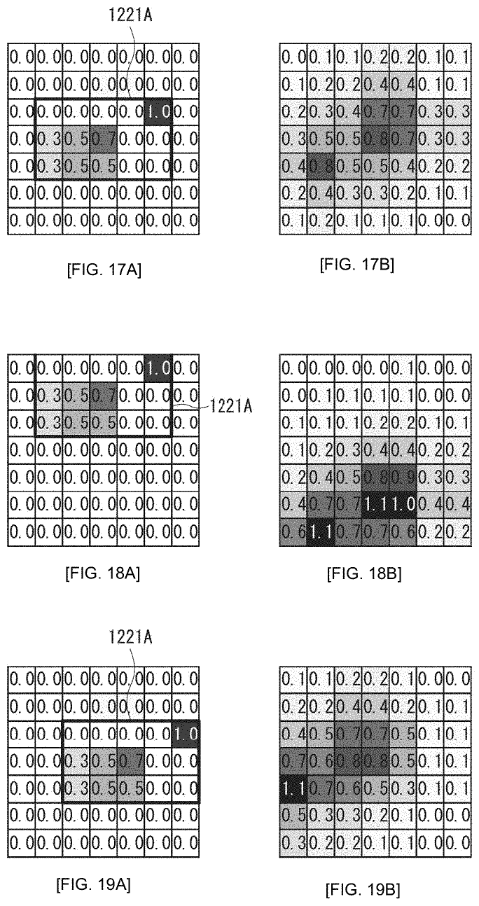

For example, as illustrated in FIG. 13A, in a state where the center positions of the projection lens 131A and the display device 1221 coincide with each other, the effective pixel region 1221A is formed at the middle of the effective region of the projection lens 131A. The relationship in this state between the light intensity (A) of each of the 7×7 regions of the region A on the screen 30 and the temperature increase (B) in each of the 7×7 regions of the projection lens 131A (region B) is as illustrated in FIG. 17. In contrast, for example, as illustrated in (A) of FIG. 18, in a case where the effective pixel region 1221A of the display device 1221 is shifted to an upper side of the screen 30A, in other words, in a case where the projection lens 131A is shifted to a lower side, the temperature increase in each of the 7×7 regions of the projection lens 131A is as illustrated in (B) of FIG. 18. In addition, for example, as illustrated in (A) of FIG. 19, in a case where the effective pixel region 1221A of the display device 1221 is shifted to a right side of the screen 30A, in other words, in a case where the projection lens 131A is shifted to a left side, the temperature increase in each of the 7×7 regions of the projection lens 131A is as illustrated in (B) of FIG. 19.

For this reason, for example, determination is made as to where in the effective region of the projection lens 131A a projection image (projection light) created by the display device 1221 enters to generate a control signal in consideration of the information thereon, thereby making it possible to perform more precise focus adjustment.

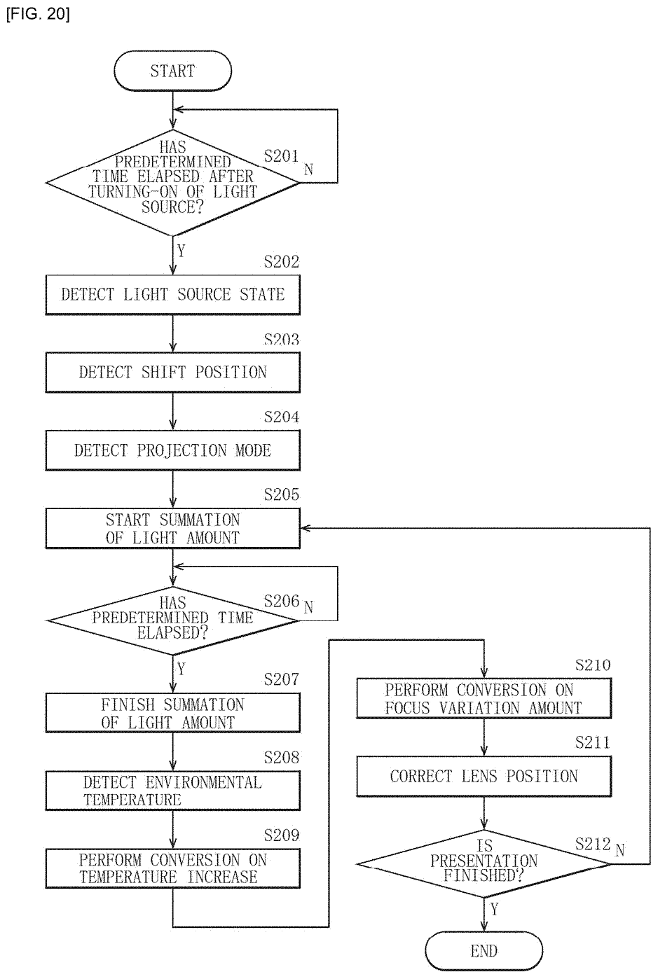

FIG. 20 illustrates a flowchart of the focus control during projection by the projection display apparatus 1A illustrated in FIG. 12.

Upon starting the focus control, first, it is confirmed whether or not a predetermined time has elapsed since the light source unit 11 was turned on (step S201). As for the confirmation as to whether or not the predetermined time has elapsed, it is sufficient to measure the time using a built-in timer, for example, after the light source unit 11 was turned on, and to confirm whether or not the measured time has exceeded the predetermined time stored in advance in the memory section 232 or the like.

In a case where the predetermined time has elapsed, the light source state detection section 221 confirms a state of the light source unit 11, and acquires the deterioration information on the light source unit 11 (step S202). In a case where the predetermined time has not elapsed, step S201 is executed after the predetermined time.

Next, the shift position detection section 223 confirms the relative position between the display device 1221 and the projection unit 13, and acquires information thereon (step S203). Subsequently, the projection mode detection section 222 confirms a projection mode selected by the user, and acquires information thereon (step S204). Next, the light amount summation section 231 starts summation of the amount of light entering the projection unit 13 (step S205). Here, in the variation weight coefficient summation part 1231, the mathematical expression represented in the above formula (1) is used to calculate the focus variation amount of the projection unit 13 corresponding to the light intensity distribution of light (projection light) entering the projection unit 13. In the variation weight coefficient summation part 1322, the focus variation amount of the projection lens 131A corresponding to the wavelength of the light (projection light) entering the projection unit 13 is calculated.

When the above-described summation of the light amount is started, it is confirmed whether or not the predetermined time has elapsed (step S206). As for the confirmation as to whether or not the predetermined time has elapsed, similarly to the case of step 5201, it is sufficient to measure the time using the built-in timer, for example, and to confirm whether or not the measured time has exceeded the predetermined time stored in advance in the memory section 232 or the like.

In a case where the predetermined time has elapsed, the light amount summation section 231 finishes the summation of the light amount (step S207). In a case where the predetermined time has not elapsed, step S206 is executed after the predetermined time.

Next, the environmental temperature detection section 224 acquires environmental information inside and outside the projection display apparatus 1A (step S208). The temperature conversion section 233 acquires a light amount summation value in each region of the projection unit 13 (specifically, projection lens 131A) from the light amount summation section 231 as well as the environmental information inside and outside the projection display apparatus 1A from the environmental temperature detection section 224, and calculates a temperature change amount in each region of the projection unit 13 (step S209). Subsequently, the correction amount calculation section 234 acquires, from the temperature conversion section 233, a temperature change amount in each region of the projection unit 13, makes conversion into a focus variation amount in the projection unit 13, and generates a control signal to be supplied to the lens shift mechanism 242 of the focus control unit 24 (step S210).

The focus control unit 24 shifts the projection unit 13 in a predetermined direction relative to the display device 1221 to perform focus adjustment on the basis of the control signal supplied from the correction amount calculation section 234 (step S211). Thereafter, for example, the correction amount calculation section 234 determines whether or not the presentation is finished (step S212). As for this step, for example, it is sufficient to confirm whether or not a picture signal is outputted to the signal processing unit 21. In a case where the presentation is not finished, steps S104 to step S110 are repeated.

In this manner, moreover, in the present modification example, the environmental temperature and the relative position between the display device (e.g., display device 1221) and the projection unit 13 are added as variables of the focus adjustment to the control algorithm, and the focus control is performed using the lens shift mechanism 242. Similarly to the foregoing embodiment, such a method also enables accurate adjustment of the out-of-focus condition during projection, thus making it possible to improve the quality of a projection image.

The description has been given hereinabove of the present technology referring to the embodiment and the modification example; however, the present technology is not limited to the foregoing embodiment and the like, and may be modified in a wide variety of ways.

In addition, the description has been given in the foregoing embodiment and the like by specifically referring to the optical members configuring the projection display apparatuses 1 and 1A; however, all the optical members need not be provided, and another optical member may further be provided.

It is to be noted that the effects described herein are merely exemplary and non-limiting, and may further include other effects.

It is to be noted that the present disclosure may also have the following configuration. According to the present technology of the following configurations, there is provided a correction unit including a first variation weight coefficient summation section that acquires a picture signal processed by a signal processing unit, and calculates a focus variation amount of a projection unit in accordance with a light intensity distribution of light entering the projection unit. On the basis of summation results in the first variation weight coefficient summation section, a focus variation of the projection unit is predicted. This enables accurate adjustment of an out-of-focus condition during projection. Thus, it is possible to improve the quality of a projection image.

(1)

A projection display apparatus including:
a light source unit;
an image formation unit including a display device that modulates light from the light source unit on a basis of an inputted picture signal to generate a projection image;
a projection unit that projects projection light generated by the display device;
a signal processing unit that acquires the picture signal and performs signal processing;
a correction unit including a first variation weight coefficient summation section that acquires the picture signal processed by the signal processing unit, and calculates a focus variation amount of the projection unit in accordance with a light intensity distribution of light entering the projection unit; and
a focus control unit that performs focus adjustment on the projection unit on a basis of information obtained from the correction unit.
   (2)

The projection display apparatus according to (1), in which the correction unit further includes a light amount summation section that temporally sums an amount of the light entering the projection unit from the picture signal.

(3)

The projection display apparatus according to (1) or (2), in which the correction unit has a control algorithm including a time factor until when the light entering the projection unit influences a focus variation.

(4)

The projection display apparatus according to any one of (1) to (3), in which the correction unit further includes a second variation weight coefficient summation section that calculates the focus variation amount of the projection unit in accordance with a wavelength of the light entering the projection unit.

(5)

The projection display apparatus according to (3) or (4), in which the control algorithm further includes, as variables of the focus adjustment, an environmental temperature and a relative position between the image formation unit and the projection unit.

(6)

The projection display apparatus according to any one of (1) to (5), in which the focus control unit includes a position adjustment mechanism that adjusts a position of the projection unit relative to the image formation unit.

(7)

The projection display apparatus according to any one of (1) to (6), in which the focus control unit includes a temperature adjustment mechanism that adjusts a temperature of the projection unit.

(8)

The projection display apparatus according to (7), in which
the focus control unit includes a plurality of the temperature adjustment mechanisms, and
the plurality of the temperature adjustment mechanisms are arranged on an outer circumference, of the projection unit, perpendicular to an optical axis of the light entering the projection unit.
   (9)

The projection display apparatus according to (7) or (8), in which the temperature adjustment mechanism includes one or two or more of a fan, a Peltier element, or a heater.

(10)

The projection display apparatus according to any one of (1) to (9), further including a first detection unit that detects a deterioration state of the light source unit.

(11)

The projection display apparatus according to any one of (1) to (10), further including a second detection unit that detects a projection mode of a picture to be projected onto a screen.

(12)

The projection display apparatus according to any one of (1) to (11), further including a third detection unit that detects a projection position of the picture to be projected onto the screen.

(13)

The projection display apparatus according to any one of (5) to (12), further including a fourth detection unit that detects the environmental temperature.

(14)

The projection display apparatus according to any one of (1) to (13), in which the display device includes a digital mirror device.

(15)

The projection display apparatus according to any one of (1) to (13), in which the display device includes a transmissive liquid crystal display device.

(16)

The projection display apparatus according to any one of (1) to (13), in which the display device includes a reflective liquid crystal display device.

This application claims the benefit of Japanese Priority Patent Application JP2020-122446 filed with the Japan Patent Office on Jul. 16, 2020, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof

1. A projection display apparatus comprising:
a light source unit;
an image formation unit including a display device that modulates light from the light source unit on a basis of an inputted picture signal to generate a projection image;
a projection unit that projects projection light generated by the display device;
a signal processing unit that acquires the picture signal and performs signal processing;
a correction unit including a first variation weight coefficient summation section that acquires the picture signal processed by the signal processing unit, and calculates a focus variation amount of the projection unit in accordance with a light intensity distribution of light entering the projection unit; and
a focus control unit that performs focus adjustment on the projection unit on a basis of information obtained from the correction unit.

2. The projection display apparatus according to claim 1, wherein the correction unit further includes a light amount summation section that temporally sums an amount of the light entering the projection unit from the picture signal.

3. The projection display apparatus according to claim 1, wherein the correction unit has a control algorithm including a time factor until when the light entering the projection unit influences a focus variation.

4. The projection display apparatus according to claim 1, wherein the correction unit further includes a second variation weight coefficient summation section that calculates the focus variation amount of the projection unit in accordance with a wavelength of the light entering the projection unit.

5. The projection display apparatus according to claim 3, wherein the control algorithm further includes, as variables of the focus adjustment, an environmental temperature and a relative position between the image formation unit and the projection unit.

6. The projection display apparatus according to claim 1, wherein the focus control unit includes a position adjustment mechanism that adjusts a position of the projection unit relative to the image formation unit.

7. The projection display apparatus according to claim 1, wherein the focus control unit includes a temperature adjustment mechanism that adjusts a temperature of the projection unit.

8. The projection display apparatus according to claim 7, wherein
the focus control unit includes a plurality of the temperature adjustment mechanisms, and
the plurality of the temperature adjustment mechanisms are arranged on an outer circumference, of the projection unit, perpendicular to an optical axis of the light entering the projection unit.

9. The projection display apparatus according to claim 7, wherein the temperature adjustment mechanism includes one or two or more of a fan, a Peltier element, or a heater.

10. The projection display apparatus according to claim 1, further comprising a first detection unit that detects a deterioration state of the light source unit.

11. The projection display apparatus according to claim 1, further comprising a second detection unit that detects a projection mode of a picture to be projected onto a screen.

12. The projection display apparatus according to claim 1, further comprising a third detection unit that detects a projection position of a picture to be projected onto a screen.

13. The projection display apparatus according to claim 5, further comprising a fourth detection unit that detects the environmental temperature.

14. The projection display apparatus according to claim 1, wherein the display device comprises a digital mirror device.

15. The projection display apparatus according to claim 1, wherein the display device comprises a transmissive liquid crystal display device.

16. The projection display apparatus according to claim 1, wherein the display device comprises a reflective liquid crystal display device.
